(19) United States
(12) Patent Application Publication
(10) Pub. No.: US 2009/0100183 A1
(43) Pub. Date: Apr. 16, 2009

(54) Detection of Missing Recipients in Electronic Messages

(75) Inventors: Derek S. Lam, Minneapolis, MN (US); Asima Silva, Holden, MA (US); Ping Wang, Westford, MA (US); Robert C. Weir, Westford, MA (US)

Correspondence Address: CUENOT & FORSYTHE, L.L.C.;Kevin T. Cuenot, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 11/872,030

(22) Filed: Oct. 14, 2007

(51) Int. Cl. G06F 15/16

(52) U.S. Cl. 709/229

(57) ABSTRACT

A computer-implemented method of identifying a missing recipient of an electronic message can include identifying at least one user specified as a recipient of an electronic message and accessing a data store comprising measures of correlation between a plurality of users, wherein the plurality of users comprises the recipient of the electronic message. One or more users not designated as a recipient of the electronic message and having a measure of correlation, with at least one recipient of the electronic message, that exceeds a predetermined threshold can be identified as a potential missing recipient of the electronic message. An indication that a recipient may have been excluded from the electronic message can be output.

### FIELD OF THE INVENTION

The embodiments of the present invention relate to electronic messaging systems and, more particularly, to detecting a missing recipient of an electronic message.

### BACKGROUND OF THE INVENTION

Electronic messaging systems have become an important means of communication within organizations and among individuals. Examples of electronic messaging systems include electronic mail systems, instant messaging systems, short-message-service (SMS) systems, text messaging systems, or the like. In an effort to keep more than one user apprised of a particular subject or project status, the same electronic message is often sent or distributed to a plurality of different recipients.

One manner of sending a message to more than one recipient is to specify each of the plurality of recipients of the electronic message on an individual basis. Such recipients can be specified in a manual fashion using the communication address of each respective recipient. Typically, such lists are formulated in an ad-hoc manner, for example, by a sender copying communication addresses from a prior electronic message and pasting the communication addresses into the electronic message being created. Under such circumstances, it is not uncommon for a particular user to be inadvertently excluded as a recipient from the newly created electronic message. For instance, the sender may include all of the recipients of a prior electronic mail as recipients in the electronic mail being composed, but neglect to include the sender of the prior electronic mail as a recipient.

Another way in which electronic messages can be distributed is through the use of a “distribution list.” A “distribution list” refers to a group of message recipients that can be addressed as a single recipient, e.g., using the name of the distribution list. Distribution lists can be used to send electronic messages to groups of recipients without having to enter the communication address for each recipient of the electronic message being sent on an individual basis. As users within organizations are promoted or move to different business units, distribution lists can change, thereby requiring constant updating. This too can lead to users being inadvertently excluded as recipients of an electronic message.

### BRIEF SUMMARY OF THE INVENTION

The embodiments disclosed herein relate to electronic messaging systems. One embodiment of the present invention can include a computer-implemented method of identifying a missing recipient of an electronic message. Measures of correlation between users from a plurality of electronic messages within an electronic messaging system can be determined. One or more users designated as recipients of an electronic message can be identified. One or more users not designated as a recipient of the electronic message and having a measure of correlation, with at least one recipient of the electronic message, that exceeds a predetermined threshold can be identified as a potential missing recipient of the electronic message. An indication that a recipient may have been excluded from the electronic message can be output.

Another embodiment of the present invention can include a computer-implemented method of identifying a missing recipient of an electronic message including identifying at least one user specified as a recipient of an electronic message and accessing a data store including measures of correlation between a plurality of users. The plurality of users can include the recipient of the electronic message. One or more users not designated as a recipient of the electronic message and having a measure of correlation, with at least one recipient of the electronic message, that exceeds a predetermined threshold can be identified as a potential missing recipient of the electronic message. An indication that a recipient may have been excluded from the electronic message can be output.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating an electronic messaging system (messaging system) for identifying missing recipients in electronic messages in accordance with one embodiment of the present invention.

FIG. 2 is a flow chart illustrating a method of determining correlations among users of a messaging system in accordance with another embodiment of the present invention.

FIG. 3 is a flow chart illustrating a method of identifying missing recipients in electronic messages in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The embodiments disclosed herein relate to determining whether one or more persons are missing, or are likely missing, as recipients of an electronic message. In accordance with the embodiments disclosed herein, electronic messages stored within an electronic messaging system (messaging system) can be analyzed to determine correlations among users. Those correlations can be stored. Recipients of a new electronic message can be evaluated with respect to the stored correlations to determine whether one or more other users not listed as a recipient of the electronic message should be specified as a recipient. The messaging system can determine that one or more recipients of the electronic message have at least a minimum correlation with one or more other users not specified as recipients of the message. The messaging system can indicate such a condition as well as take one or more other actions to be explained herein in greater detail.

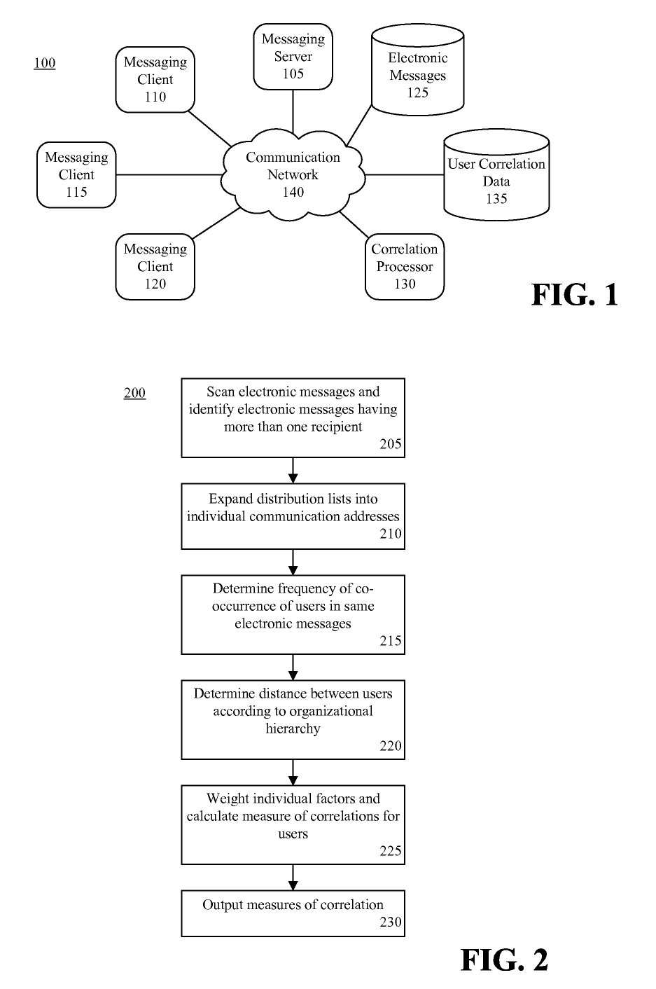

FIG. 1 is a block diagram illustrating a messaging system 100 for identifying missing recipients in electronic messages in accordance with one embodiment of the present invention. The messaging system 100 can include a messaging server 105, a plurality of messaging clients 110, 115, and 120, and a data store of electronic messages 125. The messaging system 100 further can include a correlation processor 130 and user correlation data 135. The various components of system 100 can be communicatively linked through a communication network 140.

The communication network 140 can be implemented as, or include, without limitation, a WAN, a LAN, the Public Switched Telephone Network (PSTN), the Web, the Internet, and/or one or more intranets. The communication network 140 further can be implemented as or include one or more wireless networks, whether short or long range. For example, in terms of short range wireless networks, the communication network 140 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network 140 can include a mobile, cellular, and or satellite-based wireless network and support voice, video, text, and/or any combination thereof. Examples of long range wireless networks can include GSM, TDMA, CDMA, WCDMA networks or the like.

The messaging system 100 can be implemented as, for example, an electronic mail system, an instant messaging (IM) system, a Short Messaging System (SMS), or the like. In this regard, the messaging server 105 can be implemented as an electronic mail server, an instant messaging server, an SMS server, or other communication hub or server capable of routing and storing electronic messages within or as part of the communication network 140. For messaging systems where users must have a presence, the messaging server 105, for example, can maintain user presence information indicating whether the user(s) have logged on to or are otherwise available through the messaging system 100. In any case, the messaging server 105 can include suitable operational software for performing the various functions described herein.

The messaging clients 110-120 can be implemented as any of a variety of communication devices executing suitable communication software. For example, each messaging client can be implemented as a computer system or other information processing system. One or more of the messaging clients 110-120 may also be implemented as a portable or mobile computing device, e.g., a mobile telephone, a wireless-enabled personal digital assistant, a portable computer, e.g., laptop, or the like. Each of the messaging clients 110-120 can include and/or execute suitable communication software, e.g., an IM client, an electronic mail client, or an SMS client, which enables the messaging client to communicate with the messaging server 105 and/or other messaging clients through the communication network 140 and perform the functions disclosed herein. In one embodiment, the electronic messages 125 can include more than one type of electronic message. For example, the electronic messages 125 can store any combination of electronic mails, IMs, text messages, or the like.

The data store of electronic messages (electronic messages) 125 can include a plurality of electronic messages sent among the various users of the messaging system 100. The electronic messages 125 can represent a collection of messages, or all messages, sent among one or more or all users of the messaging system 100. Whether SMS, electronic mail, IM type messages, or other sorts of electronic messages, each electronic message within the electronic messages 125 can specify one or more recipients, a sender, as well as timestamp information specifying a date and/or time the electronic message originated and/or was delivered to the recipient(s).

It should be appreciated that while a single data store is illustrated in FIG. 1, a plurality of data stores, each storing electronic messages can be included. For example, one data store can include IM type electronic messages while another includes electronic mail messages. In another example, each data store need not store electronic messages of differing types. Multiple data stores may be applicable in cases where one messaging client downloads electronic messages locally, e.g., a POP3 client, while other messaging clients interact with one or more centralized servers upon which electronic messages are stored, while allowing local replication of electronic messages to the client machine, e.g., Lotus® Notes from International Business Machines Corporation (IBM) of Armonk, N.Y. (IBM and Lotus are trademarks of International Business Machines Corporation in the United States, other countries, or both.)

As used herein, a “recipient” of an electronic message can be a user or communication address of a user specified in a “to” field of the electronic message. A recipient further can be a user or communication address specified in another field such as a “carbon copy” or “cc” field, a “blind copy” or “bc” field, or the like. Any user or communication address of a user that receives an electronic message can be considered a recipient of that electronic message. The “sender” may be considered the user or communication address from which the electronic message was sent or originated. Within this specification, the term “user” and “communication address” may be used interchangeably as each refers to a particular online entity, user identity, or profile. Likewise, the terms “sender” or “recipient” also may be used to refer to a “user” or a “communication address” of a user as the case may be.

The correlation processor 130 can process messages within the messaging system 100, e.g., electronic messages 125, whether within a single data store or located across a plurality of different data stores. The correlation processor 130 can analyze messages to determine measures of correlation among the various users listed as senders and/or recipients of the electronic messages. For example, electronic messages can be analyzed by identifying the recipients and/or senders of those messages. The correlation processor 130 can utilize various techniques for determining measures of correlation among users. Exemplary correlation determination techniques can include, but are not limited to, techniques used to suggest additional items for purchase, e.g., in the field of online shopping or commerce, techniques used to suggest additional elements of a set given one or more examples of members of the set, as well as graphing techniques capable of mapping or graphing electronic messages where senders and recipients are depicted as vertices with messaging threads linking the vertices.

Further techniques for correlation determination can include, for example, Qiu et al., “Concept based query expansions”, Proceedings of the 16th ACM SIGIR Conference on Research and Development in Information Retrieval (1993) and Perkiö et al., “Multi-Faceted Information Retrieval System for Large Scale Email Archives”, Proceedings of the 2005 IEEE/WIC/ACM International Conference on Web Intelligence, pps. 227-564 (2005). Each of the various techniques and references listed is incorporated herein by reference.

The user correlation data 135 can specify correlations among users as determined by the correlation processor 130. It should be appreciated that while the user correlation data 130 is depicted as being centrally located and/or managed, the user correlation data 130 may be stored or included within the messaging server 105 and/or within one or more of the messaging clients 110-120. In this regard, depending upon implementation of the messaging system 100, each messaging client 110-120 may reference its own set of user correlation data, access such data from the messaging server 105, and/or access the user correlation data 135. In another example, the messaging clients 110-120 and/or the messaging server 105 can synchronize internally stored user correlation data with user correlation data 135.

In operation, an electronic message can be created within one of the messaging clients, e.g., messaging client 110. At any point between creation of the message and delivery of the message to one or more of the recipients, the electronic message can be analyzed to determine whether any of the recipients of the electronic message and/or the sender exceed a minimum correlation threshold with one or more users specified in the user correlation data 135 that are not specified as recipients of the electronic message.

It should be appreciated that the correlation analysis can be performed by the messaging server 105, the messaging clients 110-120, or any combination thereof depending upon the particular implementation. In another embodiment, the correlation processor 130 can perform such analysis and may be invoked by either the messaging clients 110-120 and/or the messaging server 105. For example, prior to sending, either automatically or responsive to a user request, a messaging client, e.g., messaging client 110, can perform such an analysis. Alternatively, the messaging client 110 can request that the messaging server 105 or the correlation processor 130 perform the analysis. In that case, the recipients and/or sender of the electronic message can be forwarded to the messaging server 105 or the correlation processor 130 for analysis, e.g., prior to sending of the electronic message. In the case where the messaging server 105 performs the analysis, the messaging server 105, for example, may perform the analysis while the message is in route or within queue within the messaging server 105 awaiting delivery.

In any case, once the analysis is performed, a notification can be provided indicating whether a recipient of the electronic message has likely been excluded. The notification, which will be described herein in further detail, can be generated by the messaging client 110, the messaging server 105, or the correlation processor 130. The indication can be presented, for example, through the messaging client 110 to the sender.

FIG. 2 is a flow chart illustrating a method 200 of determining correlations among users of a messaging system in accordance with another embodiment of the present invention. The method 200 can be implemented by a system as described with reference to FIG. 1 or by a component such as the correlation processor. Accordingly, the method 200 can begin in a state in which a plurality of electronic messages have been amassed and stored within the messaging system.

In step 205, the electronic messages stored within the messaging system can be scanned. In doing so, electronic messages having more than one recipient can be identified or distinguished from those electronic messages having only one recipient. Electronic messages having a distribution list specified as a recipient can be identified as electronic messages specifying more than one recipient. In step 210, any messages that have a distribution list specified as the recipient can be expanded. That is, the distribution list can be expanded into a list naming each member of the distribution list. For example, an electronic message having a distribution list of “sales department” can be recursively expanded to specify each individual user or communication address for a user that is a member of that distribution list. Further, in cases where a distribution list itself includes other distribution lists, each such distribution list can be expanded recursively.

In step 215, the frequency of co-occurrence of users within same electronic messages can be determined. For example, the correlation processor can analyze the electronic messages stored within the electronic messaging system and determine the number of times that user A and user B were both specified as recipients within a same electronic message. Frequency of co-occurrence also can determine the number of times that users A and B were specified in the same electronic message as sender and/or recipient. The frequency of co-occurrence can be specified in terms of a count or as a percentage determined from the count compared against the entire number of messages stored within the electronic messaging system.

Frequency of co-occurrence can measure all co-occurrences over time. Frequency of co-occurrence further can be measured with respect to a predetermined time period, e.g., over the last several months or year, to more accurately reflect recent trends in user correlations. Still, co-occurrence can be broken out into different time periods that may be weighted differently, e.g., where more recent time periods are weighted more heavily than older time periods. Other ways of expressing the frequency of co-occurrence can be used apart from those examples provided herein. In any case, higher co-frequency can translate into higher correlation.

In step 220, the measures of distance between users can be determined according to an organizational hierarchy of the organization to which the users belong. An organizational hierarchy can be specified as an organization chart, as a Lightweight Directory Access Protocol directory, a plurality of user profiles, or the like. For example, distance can be observed in terms of vertical distance or levels between persons in the hierarchy, horizontal distance between persons on a same level or row of the hierarchy, or as a combination of the two. An organizational hierarchy, for instance, also can be represented as a graph where persons correspond to nodes, which can facilitate distance calculations among users.

In illustration, two or more users may have some correlation or distance, e.g., a short distance, by being located within a same department sub-unit of the organization as indicated by an organizational chart, user profiles, or the like. Two users may have some correlation or distance in that one user is the supervisor of another. Two or more users may have some correlation or distance in that both share a title such as “manager” or “vice-president.” Many relationships can be specified through organizational hierarchy beyond those examples listed herein. In general, the shorter the distance between two users, the higher the correlation between those users.

In step 225, each of the factors discussed herein, e.g., those illustrated with respect to steps 215 and 220 and any others that may be employed, can be given a weight or scaling factor. After weighting or scaling, the individual factors or measures can be combined into measures of correlation that depend upon one or more or each of the various factors discussed herein, e.g., according to weighting or scaling.

It should be appreciated that the individual measures of correlation as well as the combined measures of correlation can be specified in terms of sets of differing numbers of users. For example, when user B is a recipient, user A may have a correlation to user B. In another example, the set can be expanded to include more than two users. For instance, when both users B and C are recipients, the measure of correlation to user A may be different, e.g., stronger or weaker. In any case, the stored correlations can reflect correlations of one user to another, one user to each of a plurality of different sets of users, etc.

In step 230, the measures of correlation can be output. As used herein, “output” or “outputting” can mean, for example, writing to a file, writing to a user display or other output device, playing audible notifications, sending or transmitting to another system, exporting, or the like. For instance, the measures of correlation can be written or updated to the user correlation data, whether centrally located or on one or more messaging clients.

The method illustrated in FIG. 2 can continue operating to update correlation data in real time as further electronic messages are added to the electronic messaging system. In another aspect, correlation data can be updated periodically or from time-to-time, e.g., when the number of new electronic messages added to the electronic messaging system, or electronic messages saved since the last time correlations were determined, exceeds some predetermined threshold.

The method 200 has been presented for purposes of illustration only. FIG. 2 presents several exemplary techniques for determining measures of correlation among users, but is not intended to present a comprehensive listing of such techniques. Further techniques from the field of information retrieval that are known in the art also may be employed. In utilizing additional techniques, can use a cost function or other function that weights each individual measure and combines them into a single measure that is used as a measure of correlation.

In one embodiment, keywords can be used as a technique for determining measures of correlation. For example, one or more users may be determined to have a higher likelihood of being a recipient of an electronic message when that electronic message includes a particular keyword, whether within a subject field or within the body of the message. In another embodiment, time can be considered. For example, when an electronic message is sent on a Monday that specifies users A and B as recipients, there may be a higher likelihood that the message should specify user C as a recipient than had the message been sent on a Wednesday. This aspect can be extended to include or reference particular times of the day, seasons of the year, or the like.

In another embodiment, measures of correlation can be determined across electronic message type. For example, correlation can be determined from a review of both electronic mails and instant messages. In another embodiment, correlation can be determined from each distinct type of electronic message type. Accordingly, when determining missing recipients, correlation data can be used that is compiled across a plurality of different message types or that is compiled only for the type of electronic message that is being sent or analyzed.

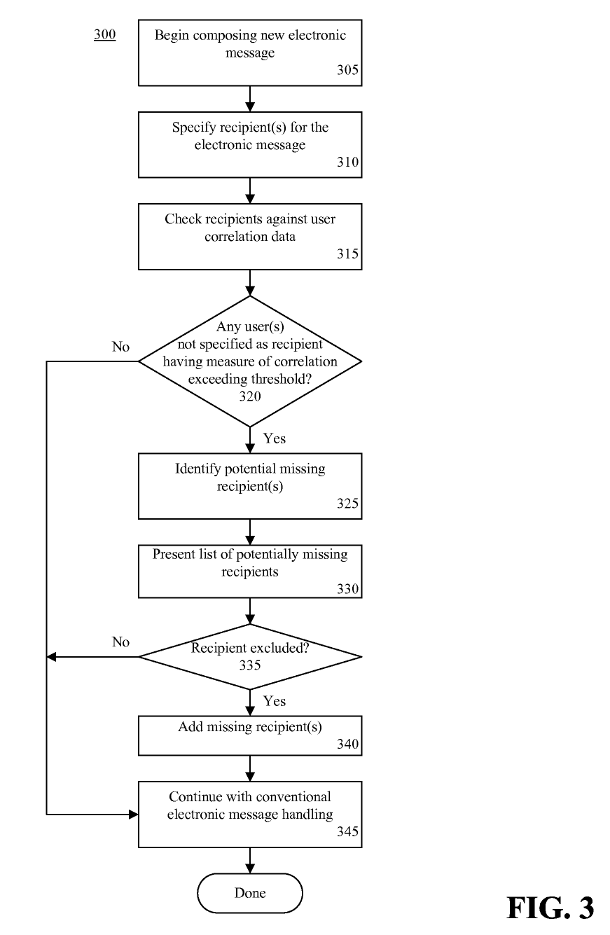

FIG. 3 is a flow chart illustrating a method 300 of identifying missing recipients in electronic messages in accordance with another embodiment of the present invention. Beginning in step 305, a user input to create a new electronic message can be received. Responsive to that input, an electronic message can be created. In step 310, one or more recipients for the electronic message can be specified. In one embodiment, recipients can be added one-by-one, e.g., manually. In another embodiment, the recipients can be specified as a distribution list or added as a group.

In step 315, the recipients specified for the electronic message can be checked, or cross-referenced, against the user correlation data. In the case where a group or distribution list is specified as the recipient, the distribution list or group can be expanded into the individual members of the distribution list or group and each member, as well as groups of members, can be checked against the correlation data.

In step 320, a determination can be made as to whether any users of the correlation data not specified as a recipient of the electronic message have a measure of correlation that exceeds a predetermined minimum measure of correlation, e.g., a threshold. If so, the method can proceed to step 345. If not, the method can continue to step 340, where conventional processing of the electronic message can be performed, e.g., completion of composition and sending.

Continuing with step 325, any potential missing recipients can be identified. Potential missing recipients can be those users identified in steps 315 and 320 that have a measure of correlation to one or more recipients of the electronic message that exceeds the threshold. In step 330, a list of the potentially missing recipients can be presented to the sender of the electronic message. The list, for example, can be provided through the messaging client software. The list further can query the sender whether one or more of the potential recipients indicated on the list has been excluded or inadvertently excluded as a recipient of the electronic message.

The sender can provide an input indicating that one or more of the potential recipients on the list was excluded or was not excluded. For example, the sender can respond with a “yes” or a “no” input. In another example, the sender can simply select one or more potential recipients from the list, thereby indicating that such users were excluded. Based upon the user input, a determination can be made in step 335 whether one or more recipients were excluded from the electronic message. If the sender indicates that none of the users from the list were excluded, the method can proceed to step 345 to continue processing the electronic message. If the sender indicates one or more of the users were excluded and indicates such persons, the method can proceed to step 340, where the selected users from the list can be automatically added as recipients to the electronic message.

In one embodiment, the list can be presented with additional controls for indicating whether the users should be added to the “to” field, the “cc” field, or the “bc” field of the electronic message. The sender can select one or more users to be added as recipients. After adding the selected users as recipients to the electronic message, the method can proceed to step 345 where the electronic message can be processed in a conventional manner in terms of sending the message over the communication network.

The method 300 described with reference to FIG. 3 has been provided for purpose of illustration. Those skilled in the art will recognize that one or more variations of the method 300 presented are within the scope of the embodiments presented herein. For example, if the messaging server performs the checking, the message can be intercepted while in route, processed, and optionally updated with one or more additional recipients. In that case, the messaging server can communicate with the messaging client to implement the various steps described in FIG. 3.

In another embodiment, the messaging system can automatically add recipients determined to have measures of correlation exceeding the threshold to the electronic message. Further, the correlation checking described with reference to FIG. 3 can be performed automatically as recipients are added to an electronic message, responsive to a specific user input or request, or automatically prior to sending the message.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of identifying a missing recipient of an electronic message, the method comprising:
determining measures of correlation between users from a plurality of electronic messages within an electronic messaging system;
identifying at least one user designated as a recipient of an electronic message;
identifying at least one user not designated as a recipient of the electronic message and having a measure of correlation, with the at least one recipient of the electronic message, that exceeds a predetermined threshold as a potential missing recipient of the electronic message; and
outputting an indication that a recipient may have been excluded from the electronic message.

2. The computer-implemented method of claim 1, wherein outputting an indication comprises automatically suggesting that the potential missing recipient be added as a recipient of the electronic message.

3. The computer-implemented method of claim 1, further comprising presenting a list comprising each user identified as a potential missing recipient.

4. The computer-implemented method of claim 1, wherein outputting an indication comprises automatically adding the potential missing recipient as a recipient of the electronic message.

5. The computer-implemented method of claim 1, wherein identifying at least one user designated as a recipient comprises recursively expanding a distribution list specifying a plurality of recipients of an electronic message into constituent members of the distribution list.

6. The computer-implemented method of claim 1, wherein determining measures of correlation comprises determining frequency of co-occurrence of recipients within same electronic messages of the plurality of electronic messages.

7. The computer-implemented method of claim 1, wherein determining measures of correlation comprises determining frequency of co-occurrence of users specified as recipients or senders within same electronic messages of the plurality of electronic messages.

8. The computer-implemented method of claim 1, wherein determining measures of correlation comprises determining a distance between users within an organizational hierarchy.

9. The computer-implemented method of claim 8, wherein determining measures of correlation comprises determining that two users are within a same organizational sub-unit of an organizational hierarchy.

10. A computer-implemented method of identifying a missing recipient of an electronic message, the method comprising:
identifying at least one user specified as a recipient of an electronic message;
accessing a data store comprising measures of correlation between a plurality of users, wherein the plurality of users comprises the recipient of the electronic message;
identifying at least one user not designated as a recipient of the electronic message and having a measure of correlation, with at least one recipient of the electronic message, that exceeds a predetermined threshold as a potential missing recipient of the electronic message; and
outputting an indication that a recipient may have been excluded from the electronic message.

11. The computer-implemented method of claim 10, wherein outputting an indication comprises automatically suggesting that the potential missing recipient be added as a recipient of the electronic message.

12. The computer-implemented method of claim 10, further comprising presenting a list comprising each user identified as a potential missing recipient.

13. The computer-implemented method of claim 10, wherein outputting an indication comprises automatically adding the potential missing recipient as a recipient of the electronic message.

14. A computer program product comprising:
a computer-usable medium comprising computer-usable program code that identifies a missing recipient of an electronic message, the computer-usable medium comprising:
computer-usable program code that identifies at least one user specified as a recipient of an electronic message;
computer-usable program code that accesses a data store comprising measures of correlation between a plurality of users, wherein the plurality of users comprises the recipient of the electronic message;
computer-usable program code that identifies at least one user not designated as a recipient of the electronic message and having a measure of correlation, with at least one recipient of the electronic message, that exceeds a predetermined threshold as a potential missing recipient of the electronic message; and
computer-usable program code that outputs an indication that a recipient may have been excluded from the electronic message.

15. The computer program product of claim 14, wherein the computer-usable program code that outputs an indication comprises computer-usable program code that automatically suggests that the potential missing recipient be added as a recipient of the electronic message.

16. The computer program product of claim 14, further comprising computer-usable program code that presents a list comprising each user identified as a potential missing recipient.

17. The computer program product of claim 14, wherein the computer-usable program code that outputs an indication comprises computer-usable program code that automatically adds the potential missing recipient as a recipient of the electronic message.

18. The computer program product of claim 14, wherein the measures of correlation depend upon frequency of co-occurrence of recipients within same electronic messages.

19. The computer program product of claim 14, wherein the measures of correlation depend upon frequency of co-occurrence of users specified as recipients or senders within same electronic messages.

20. The computer program product of claim 14, wherein the measures of correlation depend upon distances between users within an organizational hierarchy.
